(19) United States
(12) Patent Application Publication
(10) Pub. No.: US 2009/0066177 A1
(43) Pub. Date: Mar. 12, 2009

(54) Micro Kinetic energy device for powering portable electronic devices

(76) Inventor: Donald R. Loke, Danbury, CT (US)

Correspondence Address: COOPER & DUNHAM, LLP, 30 Rockefeller Plaza, 20th Floor, NEW YORK, NY, 10112, US

(21) Appl. No.: 12/231,393

(22) Filed: Sep. 2, 2008

Related U.S. Application Data
(60) Provisional application No. 60/968,960, filed on Aug. 30, 2007.

(51) Int. Cl. H02K 7/18; H02K 7/116

(52) U.S. Cl. 310/83; 310/75 A

(57) ABSTRACT

An energy conversion and storage device includes a winding bezel, having a winding bezel top plate, a bezel ring, and a central winding arbor, a winding pinion rotatingly positioned on the winding arbor, first and second barrels mounted for rotation on a barrel arbor, the barrels linked by teeth thereon so that the first barrel drives the second barrel, a ratchet wheel rotatingly connected to the winding bezel and to the barrel arbor and a drive wheel and drive pinion operably connected to the barrel arbor and an electric generator, such that turning the winding bezel turns the ratchet wheel to turn the first barrel which winds the second barrel and the drive wheel and drive pinion to rotate the electric generator.

### CROSS-REFERENCE TO RELATED APPLICATION

This application claims priority of U.S. Provisional Patent Application No. 60/968,960, filed Aug. 30, 2007, the entire contents of which are hereby incorporated by reference.

### FIELD OF THE INVENTION

This invention relates to powering portable electronic devices such as laptop computers, communication devices, GPS systems, medical devices, sensors, and other portable devices with or without batteries. More particularly, the invention relates to a mechanically wound generator and energy store that supplies power to an electronic or electric device.

### BACKGROUND OF THE INVENTION

The present invention provides a mechanically driven energy source to reduce the demand and production of batteries that have a significant impact on our environment and have a limited life span. This invention may be able to eliminate reliance on batteries for some devices, and avoid using and discarding the toxic chemicals they contain. This invention will provide another long term solution to our energy needs by giving the end user a device that will run without needing to rely upon batteries and external chargers or other independent power sources.

Batteries today often contain toxic materials including lithium, nickel, cadmium, mercury, and have limited life span therefore ending up being disposed of or thrown away in our landfills and seeping into our water supply. A very small percentage of batteries are recycled properly most are thrown in the garbage.

The dependence on an external power supply such as a battery significantly limits the usage of portable electronic devices for long periods of time, or where there is no electrical source to recharge the batteries. There is a need for a portable, mechanical energy generator that can convert mechanical energy to electric power and can be used to power an electronic device such as a laptop computer, or many military devices that rely on batteries. The system can also work with batteries to recharge the battery or maintain its energy level, therefore giving the energy cell longer life and reducing the need to replace them frequently.

### SUMMARY OF THE INVENTION

In one embodiment, the present invention provides a wind up energy source to power electronic devices and energize the battery system by providing supplemental energy to the battery(s). This system can use batteries, capacitors or other electronic storage devices to store the power until needed.

Kinetic energy is stored in mainsprings that are traditionally wound into a barrel. The mainspring delivers this power to the train wheels, which in turn spin at a predetermined speed depending on the construction of the gearing. This gearing drives a pinion locked on an armature of a generator. The generator generates the required voltage based on the design of the generator and the speed at which it spins. These generators can be designed to deliver between 1.5 volts to 48 volts, although other voltages may be obtainable.

The kinetic energy stored in the second barrel helps maintain the energy of the mainspring in the first barrel. This invention includes the use of multiple barrels as necessary to provide the system with the torque and power reserve necessary according to the specifications of the device. The double or multiple barrel systems also provides a more uniform or constant force of energy to the gearing and a longer run down time period or power reserve.

Manual winding of the mainsprings will be done via a rim wind system whereby the outside bezel/barrel is manually turned to wind and restore the energy stored in the mainspring(s). Turning the bezel restores the windings of the mainsprings in each barrel. On the inside rim of the barrel/bezel will reside a hook that will engage with the outer end of the mainspring, which winds the spring as the rim is turned. A winding arbor is attached to the inside coil of the mainspring that in turn drives the train wheels of the device. Another variation is a rim wind with a center arbor that engages and drives the ratchet wheel. The ratchet wheel will engage with an intermediate winding wheel, which drives the winding wheel of the second barrel. The second barrel is therefore wound together with the first. With this system one or more barrels can be used to power the device.

A generator or generators are used to create the new energy in the form of electrical DC power. The energy of the mainspring spins the gearing, which is driving the armature through the pinion attached to the armature at one end. The speed of the armature will be dependent on the design of the gearing system, which in turn will determine the voltage output of the system. The generator, which may include a series of generators linked together, converts the mechanical energy into electrical energy.

An electronic circuit will divide the energy and supply the contacts with the value necessary to run the device. The configurations will be dependent on the designs of the original equipment.

In another embodiment, the winding of barrel/bezel will wind the mainspring contained within, which in turn is attached to the arbor. This arbor will then turn the inner coils of the mainspring in the second barrel. The barrel will then drive the pinion via the outside gear. The pinion will drive intermediate wheel, which drives the train wheels. These wheels then will drive the pinion/gear on the generator. Within the electronic housing are the electronic circuits, generator/generators, and energy storage.

### BRIEF DESCRIPTION OF THE DRAWINGS

Further features and advantage, of the invention will become apparent upon review of the following detailed description of the preferred embodiments taken in connection with the following drawings, in which:

FIG. 1 is an exploded view of one preferred embodiment of the power winding and storage device of the present invention; and

FIG. 2 is an exploded view of another preferred embodiment of the power winding and storage device of the present invention.

### DETAILED DESCRIPTION OF THE PREFERRED EMBODIMENT

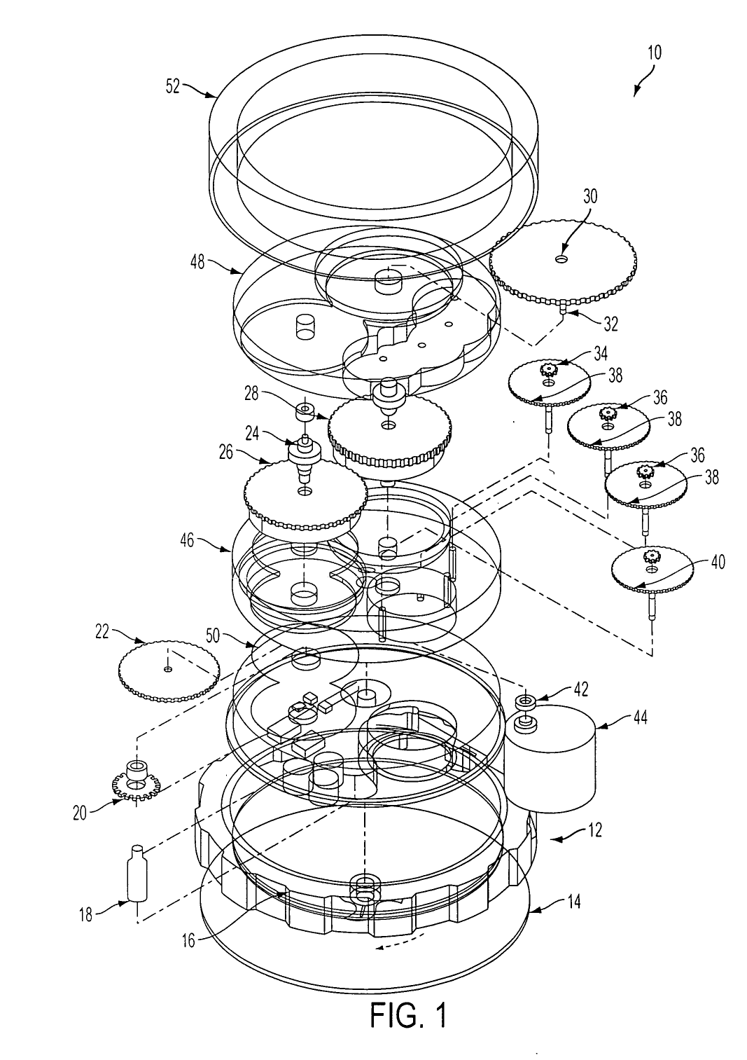

Referring to the drawings, FIG. 1 depicts an exploded view of the energy winding and storage device of present invention, generally designated by reference numeral 10. The winding bezel 12 is made up of three parts, a winding bezel top plate 14, a bezel ring 16 and a center winding arbor 18 or post respectively. On the winding arbor 18 fits a winding pinion 20. The bezel 12 when turned counterclockwise turns the ratchet wheel. The ratchet wheel 22 fits to barrel arbor, which when turned winds the mainspring 21 inside the barrel. There are two barrels in series which are linked via the barrel teeth on the perimeter, and one barrel drives the other. As one barrel is wound, it winds the other, and as they run down they will both unwind together giving the system uniform power and longer endurance. This system can run as many barrels as necessary to power the device.

The driving wheel 30 and pinion 32 are driven by the barrel arbor in barrel number 28. The power goes through a series of wheels and pinions 34, 36, 38, and 40, which drives pinion 42 mounted on the post of the generator. These components are assembled between the mainplate 46 and train bridges 48 and 50.

The generator 44 creates electricity by spinning the arbor at a specific RPM. The faster the arbor spins, the more current is created. The speed is determined by the ratio of gearing included in the mechanism, and can create from 1.5 volts to 48 volts, or more. The entire mechanism is housed inside casing and the bezel assembly. The casing is water-resistant and shock proof.

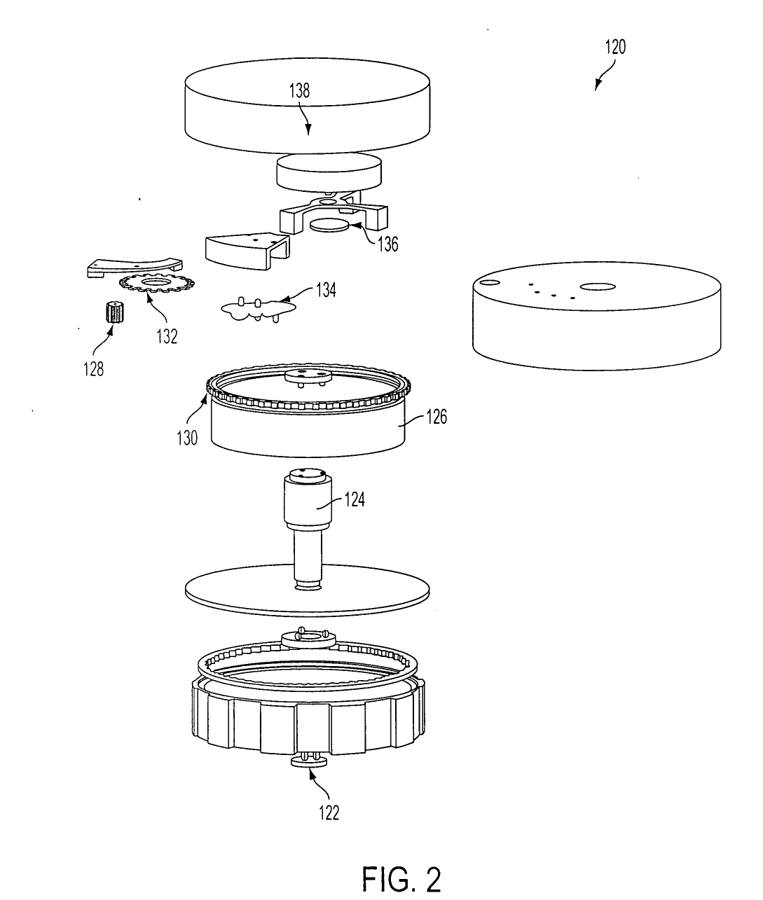

FIG. 2 illustrates another preferred embodiment of the invention designated by reference numeral 120. In this embodiment, the winding of barrel or bezel 122 winds the mainspring contained within (not shown), which in turn is attached to arbor 124. This arbor 124 will then turn the inner coils of the mainspring in the second barrel 126. The barrel 126 will then drive pinion 128 by the gear 130. The pinion will drive intermediate wheel 132 which drives the train wheels 134. These wheels then will drive the pinion/gear 136 on the generator 138. Within the generator 138 are an electronic circuit to control generator 138, and one or more energy storage batteries or capacitors.

In either case, the generator is preferably a flat disk generator, which is commonly available from electrical supply outfits. Its size and power output are selected to provide the appropriate output voltage and current for the chosen application, given the size constraints of the powering device and the powered application. In one preferred embodiment the generator has multiple flat discs having a dielectric material filled with silver, which is diamond coated, spinning over magnets. The magnets are on the center of two discs which are spun over and under the stationary magnets. These can be stacked to create different voltages and amperes.

Similarly, the regulator or control circuit should be chosen or designed to control the generator and smooth out and adjust, where desired, the output profile of the energy created by turning the winding bezel. The battery can be a lithium battery or a nickel cadmium battery, or any battery that can be recharged electrically by a generator and will store the charge to deliver it at a later time. Preferably, the battery should be very compact and highly efficient in order to reduce the size and weight of the energy conversion device of the present invention, when used with a battery.

As should be apparent to a person of ordinary skill, the invention has been described with reference to the presently preferred embodiments. Many modifications and adaptations will be apparent to those skilled in the art, and all such modifications are intended to be within the scope of the invention, as defined by the following claims.

I claim:

1. An energy conversion and storage device, comprising:
a winding bezel, having a winding bezel top plate, a bezel ring, and a central winding arbor;
a winding pinion rotatingly positioned on the winding arbor;
first and second barrels mounted for rotation on a barrel arbor, the barrels linked by teeth thereon so that the first barrel drives the second barrel;
a ratchet wheel rotatingly connected to the winding bezel and to the barrel arbor; and
a drive wheel and drive pinion operably connected to the barrel arbor and an electric generator, such that turning the winding bezel turns the ratchet wheel to turn the first barrel which winds the second barrel and the drive wheel and drive pinion to rotate the electric generator.

2. An electric conversion device according to claim 1, additionally comprising a battery to store electric energy created by turning the winding bezel.

3. An electric conversion device according to claim 2, additionally comprising an electrical control circuit for smoothing out and adjusting the electrical output of the generator.

4. An electrical conversion device according to claim 2, wherein the generator is a flat disk generator.

5. An energy conversion device according to claim 4, wherein the battery is a lithium battery.

6. An energy conversion device according to claim 4, wherein the battery is a nickel cadmium battery.

7. An energy conversion device, comprising:
a winding bezel having a top plate, a bezel ring, and a center winding arbor;
a first mainspring located within a first barrel and operably connected to the center winding arbor;
a second mainspring located within a second barrel and operably connected to the center winding arbor;
a generator and a drive pinion and gear operably connected to drive the generator; and
a battery electrically connected the generator for receiving and storing electric energy created by turning the winding bezel.

8. An energy conversion device according to claim 7, further comprising an electrical control circuit for smoothing and adjusting the electrical output of the generator.

9. An electrical conversion device according to claim 7, wherein the generator is a flat disk generator.

10. An energy conversion device according to claim 9, wherein the battery is a lithium battery.

11. An energy conversion device according to claim 9, wherein the battery is a nickel cadmium battery.
